(19) United States
(12) Patent Application Publication
(10) Pub. No.: US 2011/0222668 A1
(43) Pub. Date: Sep. 15, 2011

(54) Method for In-Country Live Testing of International Telephone Numbers

(76) Inventor: Stephen Levenson, Weston, FL (US)

(21) Appl. No.: 13/113,757

(22) Filed: May 23, 2011

(51) Int. Cl. H04M 3/22

(52) U.S. Cl. 379/27.01

(57) ABSTRACT

Worldwide In-country live telephone number testing is performed by a human tester located in a specific country using local Public Switched Telephone Network (PSTN) access to make outbound test calls in order to test telecommunications Quality of Service (QoS). International telephone communication has become increasingly vital in the areas of customer service, sales, and the global business cycle which have come to increasingly depend on international telephone communication. The QoS criteria tests functions including, but is not limited to: correct message; message in proper language; Dual Tone Multi Frequency (DTMF) prompts working; static; echo; cross-talk; fading in & out of conversations; speech volume; pass codes; leader pins; and the like. The results of QoS tests allow early detection of problems before those problems become serious business issues.

### BACKGROUND OF THE INVENTION

The present invention relates to testing the Quality of Service (QoS) of telecommunications and in particular live in-country testing of the QoS of international telephone numbers.

As the cost of international telephone service has drastically dropped over the past decade, the use of international telephone services has expanded exponentially. Order taking, technical assistance, conference calling, and general conducting of international business often depends on the availability of high quality and reliable telephone service. Unfortunately, QoS issues often arise and defeat the advantages of the low cost international telephone services. In some instances, businesses only become aware of international telephone service problems when customers complain of problems, which often results in loss of customers and revenue. Because of the growing reliance on international telephone service, these QoS issues require rapid and accurate identification, and even faster resolution.

### BRIEF SUMMARY OF THE INVENTION

The present invention addresses the above and other needs by providing in-country live testing in 145 countries. Testing is performed by a human tester located in a specific country using local Public Switched Telephone Network (PSTN) access to make outbound test calls in order to test telecommunications Quality of Service (QoS). International telephone communication has become increasingly vital in the areas of customer service, sales, and the global business cycle which have come to increasingly depend on international telephone communication. The QoS criteria tests functions including, but is not limited to: correct message; message in proper language; Dual Tone Multi Frequency (DTMF) prompts working; static; echo; cross-talk; fading in & out of conversations; speech volume; pass codes; leader pins; and the like. The results of QoS tests allow early detection of problems before those problems become serious business issues.

In accordance with one aspect of the invention, there is provided a method for international live testing of telephone numbers. The method includes the steps of locating a human tester in a first country; placing live phone calls to a client number; mimicking a customer calling the client; evaluating the Quality of Service (QoS) of the connection and client employee in a second country; preparing a Call Display Record (CDR) for the call, providing the CDR to a CDR collection and processing provider; and compiling, summarizing, and providing the CDR to the client.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Human testers living in a first country place in-country calls over a landline and/or mobile phone attempting to connect to a client's telephone number in a second country. Human phone number testing, results collection, and processing services are presently offered in 145 countries. The testers verify connection and evaluate each call for overall Quality of Service (QoS). The testers mimic a customer's clients in the first country attempting to make outbound calls from a landline or mobile phone in the first country to sales or technical support lines in the second country. The tester completes one Call Display Record (CDR) (e.g., spreadsheet) per test call and sends the CDR to a CDR collection and processing provider. The CDR's are compiled, summarized, and provided to the client so the client can determine if the QoS is meeting the client's requirements or expectations.

Results of testing international toll-free, Toll, Universal International Freephone Number (UIFN), Voice over Internet Protocal (VOIP), Direct Inward Dialing (DID), and all international telephone numbers, provides clients with confirmation of whether or not the client's mission critical international telephone numbers are operational and satisfying the client's requirements. When problematic telephone numbers are detected, the clients are immediately notified so that the clients may address the service issue promptly so that service can be maintained and/or restored as quickly as possible.

The CDR collection and processing provider may further provide a global footprint to it's customers. When problems are identified, testers can, at the request of the client, work directly with local in-country telecom carriers in order to report trouble tickets directly, and resolve service issues much more rapidly than the client is able to do before on their own. Because a client's revenue, profits, and reputation may significantly suffer from a breakdown in international telecommunication, such immediate action is important and less expensive and/or more timely than the client sending personnel to address the problem with the local in-country telecom carriers.

The CDR collection and processing provider may further test new international telephone numbers as requested by customers. The new international numbers may be tested and confirmed as operational before delivering/releasing to customers to prevent costly and embarrassing failures.

The CDR collection and processing provider may further test existing international telephone numbers as requested by customers when service issues are reported. The reported numbers may be tested and problems characterized and reported to minimize costly and embarrassing failures.

When severe and persistent international telecommunications service failures are present, customers can potentially lose clients. Customers of the CDR collection and processing provider may now request live cooperative testing with the local in-country telecom carriers in order to identify, isolate, and remedy the service issues. The customers were not able to perform this detailed cooperative testing before the CDR collection and processing provider offered these services to its global customers.

The global telephone companies may further engage the CDR collection and processing provider to make local in-country outbound test calls in order verify the numbers preventing any disabled or invalid numbers from being distributed. Once an invalid number is detected by the CDR collection and processing provider, the client is promptly notified enabling them to correct these issues immediately.

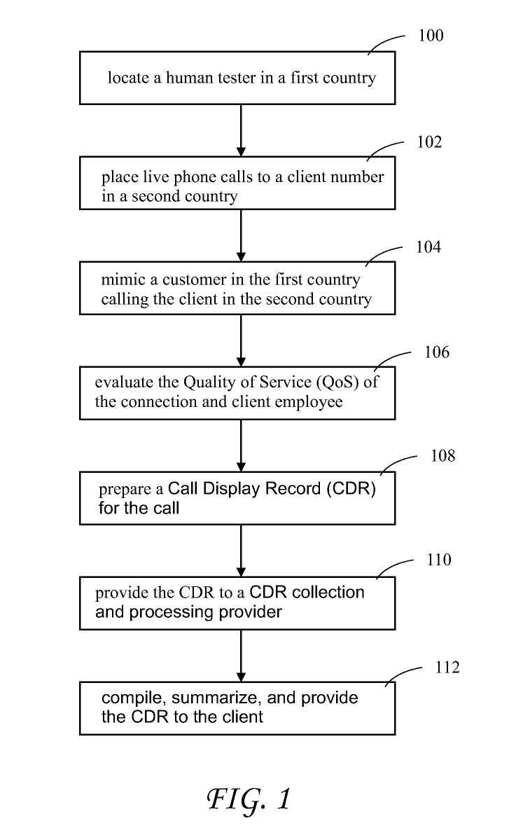

A method according to the present invention is shown in FIG. 1. The method includes the steps of locating a human tester in a first country at set 100; placing live phone calls to a client number at step 102; mimicking a customer calling the client at step 104; evaluating the Quality of Service (QoS) of the connection and client employee in a second country at step 106; preparing a Call Display Record (CDR) for the call at step 108; providing the CDR to a CDR collection and processing provider at step 110; and compiling, summarizing, and providing the CDR to the client at step 112.

Most global corporations rely on international conferencing and communications in order to conduct business in today's marketplace. The methods of the present invention performed by the CDR collection and processing provider enable global corporations to conduct business as usual with the confidence of knowing that their mission critical international telephone numbers are operational and revenue producing. Using known methods, the global corporations depend on their customers to notify them of problems which is the worst possible customer service.

While the invention herein disclosed has been described by means of specific embodiments and applications thereof, numerous modifications and variations could be made thereto by those skilled in the art without departing from the scope of the invention set forth in the claims.

I claim:

1. A method for international live testing of telephone numbers, the method comprising:
locating a human tester in a foreign country;
placing live phone calls by the human tester to a client number;
mimicking a customer calling the client;
evaluating the Quality of Service (QoS) of the connection and client employee in a second country;
preparing a Call Display Record (CDR) for the call;
providing the CDR to a CDR collection and processing provider; and
compiling CDRs;
summarizing CDRs; and
providing the compiled and summarized CDRs to the client.

2. A method for international live testing of telephone numbers locating a human tester in a first country, the method comprising:
placing live phone calls to a client number;
evaluating the Quality of Service (QoS) of the connection and client employee in a second country; and
providing a summary of the QoS to the client.

3. A method for international live testing of telephone numbers, the method comprising:
locating a human tester in a first country;
placing live phone calls by the human tester to a client number in a second country;
mimicking a customer in the first country calling the client in the second;
evaluating the Quality of Service (QoS) of the connection and client employee in a second country;
preparing a Call Display Record (CDR) for the call;
providing the CDR to a CDR collection and processing provider; and
compiling CDRs;
summarizing CDRs; and
providing the compiled and summarized CDRs to the client.
